(19) United States
(12) Patent Application Publication
(10) Pub. No.: US 2020/0206929 A1
(43) Pub. Date: Jul. 2, 2020

(54) DUPLICATE SERVO ID DETECTION METHODS AND SERVO FOR ROBOT

(71) Applicant: UBTECH ROBOTICS CORP LTD, Shenzhen (CN)

(72) Inventors: Youjun XIONG, Shenzhen (CN); Hanyu Sun, Shenzhen (CN); Lifu Zhang, Shenzhen (CN); Wenhua Fan, Shenzhen (CN); Zhongliang Wang, Shenzhen (CN); Jianxin Pang, Shenzhen (CN)

(21) Appl. No.: 16/727,956

(22) Filed: Dec. 27, 2019

(30) Foreign Application Priority Data
Dec. 29, 2018 (CN) 201811642408.3

(51) Int. Cl. B25J 9/16

(52) U.S. Cl. CPC B25J 9/1674; B25J 9/1628

(57) ABSTRACT

The present disclosure provides duplicate servo ID detection methods and a servo for a robot. One of the method includes: transmitting, by the main controller, a query instruction including a specific servo ID to at least two of the servos of the robot through a bus; differentiating feedback information replied by at least two of the servos corresponding to the specific servo ID; and determining, by the main controller, there being at least two of the servos with the same servo ID, if the feedback information not meeting a predetermined verification rule is received. Through the technical solution provided by this embodiment, the detection of duplicate servo ID can be realized, and the servos on the bus that have the same servo ID can be found so us to remind the user of the robot, thereby guaranteeing the normal operation of the robot.

### TRAVERSE REFERENCE TO RELATED APPLICATION PROGRAMS

This application claims priority to Chinese Patent Application No. CN 201811642408.3, filed Dec. 29, 2018, which is hereby incorporated by reference herein as if set forth in its entirety.

### BACKGROUND

### 1. Technical Field

The present disclosure relates to robot technology, and particularly to duplicate servo ID detection methods and a servo for a robot.

### 2. Description of Related Art

With the rapid development of the social economy and the gradual improvement of science and technology, the use of robots has involved more and more fields.

For a robot, during its assembly, the servos of the components of the robot often need to be assigned with different IDs (identities). However, for the assembly process of some robots, multiple processes are often required, and even needs to be performed in different workshops. As a result, if the servo ID assigned to each servo in each process become duplicated, it will be difficult to find. Moreover, during the operation of the robot, a main controller of the robot sends a control instruction to each servo, and the servo in turn controls its corresponding component to realize a corresponding motion, thereby realizing the motion control of the robot. Therefore, if the servo ID is duplicate on the bus (i.e., there are the servos with the same servo ID on the bus), there will be confusion in the motion of the robot, and even causes the motion of the component to beyond its capability and even damages the servo or the component.

### BRIEF DESCRIPTION OF THE DRAWINGS

To describe the technical schemes in the embodiments of the present disclosure more clearly, the following briefly introduces the drawings required for describing the embodiments or the prior art. Apparently, the drawings in the following description merely show sonic examples of the present disclosure. For those skilled in the art, other drawings can be obtained according to the drawings without creative efforts.

FIG. 1 is a flow chart of a duplicate servo ID detection method according to embodiment 1 of the present disclosure.

FIG. 2 is a flow chart of a duplicate servo ID detection method according to embodiment 2 of the present disclosure.

FIG. 3 is a schematic block diagram of a main controller for a robot according to embodiment 3 of the present disclosure.

FIG. 4 is a schematic block diagram of a servo for a robot according to embodiment 4 of the present disclosure.

FIG. 5 is a schematic block diagram of the structure of a robot according to embodiment 6 of the present disclosure.

FIG. 6 is a schematic block diagram of the structure of a servo of a robot according to embodiment 7 of the present disclosure.

### DETAILED DESCRIPTION

The present disclosure will be further described in detail below with reference to the drawings and embodiments. It is to be understood that, the embodiments described herein are merely for explain the present disclosure, instead of limiting the present disclosure. Furthermore, it should be noted that, for the convenience of description, only some but not all of the parts related to the present disclosure are shown in the drawings,

Before discussing the embodiments in more detail, it should be noted that, some exemplary embodiments are described as a process or method through a flowchart. Although the steps in the flowchart are described as a sequential process, the steps can be implemented in parallel, concurrently, or simultaneously. In addition, the order of the steps can be changed. The process may be terminated when its operation is completed, and may also include additional steps not included in the drawings. The processing may correspond to methods, functions, procedures, subroutines, subprograms, and the like.

### Embodiment 1

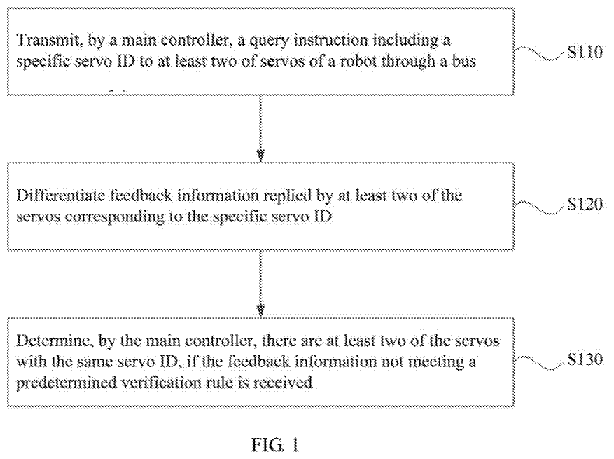

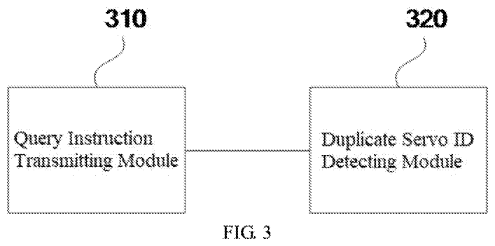

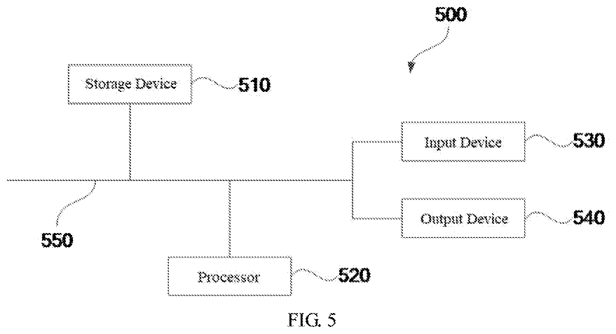

FIG. 1 is a flow chart of a duplicate servo ID detection method according to embodiment 1 of the present disclosure. In this embodiment, a duplicate servo ID (identity) detection method for a robot having a main controller and servos is provided, where the main controller and the servos communicate with each other via a bus. The method can be applied to the main controller for detecting servo IDs of the servos, where a communication interface of the main controller is connected with at least two servos in series. In which, the servo is driven by a motor, and may be used as a joint of the robot so as to realize the movement of a limb of the robot which connected to the joint. The method is u computer-implemented method executable for a processor of the robot, which may he implemented through and applied to a main controller shown in FIG. 3 that is for a robot or a robot shown in FIG. 5, or implemented through a storage medium of embodiment 5 of the present disclosure. As shown in FIG. 1, the method includes the following steps.

S110: transmitting, by the main controller, a query instruction including a specific servo ID to at least two of the servos of the robot through a bus.

S120: differentiating feedback information replied by at least two of the servos corresponding to the specific servo ID.

In which, the servo may be a motion execution unit of a certain component of the robot, for example, an arm of the robot, which can be provided with a servo to receive a motion control instruction transmitted by the main controller to the servo and perform a corresponding motion according to the motion control instruction. In general cases, each servo has a unique servo ID (i.e., the servo IDs of the servos are different from each other) to report to the main controller. The robot will detect the servo ID of each servo before use, for example, it can send a query instruction to the servo with the servo ID of 3, and the servo with the servo ID of 3 will reply the feedback information for the main controller to determine that the servo with the servo ID of 3 is present and normal after the servo with the servo ID of 3 receives the query instruction, and then the servo with the servo ID 4 can be authenticated. However, in some special cases, if there are two servos with the servo ID of 3, for example, the servo of an arm and the servo of a leg, the servo of the arm and the servo of the leg will both reply the feedback information after receiving the query instruction. In this case, since the main controller receives the same feedback information at the same time, it cannot remove duplicates.

Therefore, in this embodiment, after receiving the query instruction, the servo replies the feedback information in a manner different from other of the servos by, for example, setting a reply delay duration of the feedback information as a random duration, or attaching a special mark such as a unique identifier of the servo itself to the feedback information, so that the main controller can receive different feedback information differently on the bus in the case that the specific servo ID is duplicate.

S130: determining, by the main controller, there being at least two of the servos with the same servo ID, if the feedback information not meeting a predetermined verification rule is received.

In which, after receiving the query instruction, the servo checks whether the specific servo ID in the query instruction matches a local servo ID of the servo itself, and if so, it generates the feedback information to reply to the main controller.

If the main controller receives the feedback information replied by at least two of the servos in response to the query instruction, it can be determined that there is a duplication of the specific servo ID included in the query instruction.

In one embodiment, step S120 includes: making reply times of at least two of the servos corresponding to the specific servo ID different.

In which, it makes the reply lime different so that the superimposed information of the feedback information not meet a verification code of a preset verification software.

In which, the servos with the same servo ID reply the feedback information in a manner different from other of the servos by replying the feedback information in a random time, for example, if the reply is performed in a random time within 10 seconds, the main controller may receive the feedback information replied by one servo at 1th second after transmitting the query instruction, and further receives the feedback information replied by another servo at 4th second after transmitting the query instruction, then it can determine that the specific servo ID in the current query instruction is duplicate on the bus. In which, since both servos use random times, the probability of the times to receive the feedback information to be the same is almost zero, and replying the query instruction by delaying for a random time can be used in a microcontroller unit (MCU) of each servo. Therefore, the main controller can determine whether the specific servo ID is duplicate on the bus (i.e., whether there are the servos with the same specific servo ID on the bus) when checking the servo ID.

In another embodiment, step S120 includes: adding an identification code of an MCU of the servo to the feedback information of the servo such that the feedback information replied by at least two of the servos at the same time different with each other to cause the superimposed feedback information received by the main controller not meeting the predetermined verification rule set by the verification software. It is noted that the MCU identification code of each servo is unique.

In other embodiment, it can add a random number instead of the MCU identification code to the feedback information so that the superimposed information of the feedback information not meet a preset check mechanism of the feedback information.

The advantage of this setting is that the main controller can be informed in time when the specific servo ID is duplicate on the bus, while the speed of the robot to check the servo IDs of the servos will not be affected.

In the technical solution provided by this embodiment, the query instruction including the specific servo ID is transmitted to all the servos of the robot on the bus, where the query instruction is for causing at least one of the servos corresponding to the specific servo ID to reply feedback information; and the specific servo ID in the query instruction is determined as duplicated on the bus, if a superimposed information of the at least two sets of the feedback information corresponding to the query instruction does not pass the verification of a verification software. Through the technical solution provided by this embodiment, the detection of duplicate servo ID can he realized, and the servos on the bus that have the same servo ID can be found so as to remind the user of the robot, thereby guaranteeing the normal operation of the robot.

### Embodiment 2

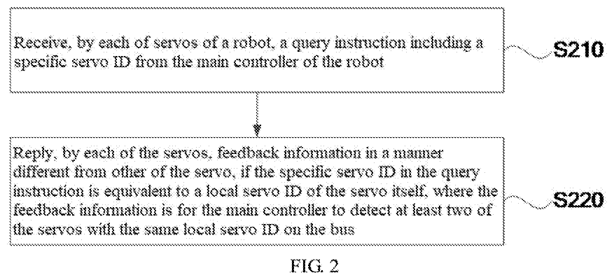

FIG. 2 is a flow chart of a duplicate servo ID detection method according to embodiment 2 of the present disclosure. In this embodiment, a duplicate servo ID detection method for a robot having a main controller and servos is provided, where the main controller and the servos communicate with each other via a bus. The method can be applied to a processor such as an MCU of the servo. In which, the servo is driven by a motor, and may be used as a joint of a robot so as to realize the movement of a limb of the robot which connected to the joint. The method is a computer-implemented method executable for a processor, which may he implemented through and applied to a main controller shown in FIG. 3 that is for a robot or a robot shown in FIG. 5, or implemented through a storage medium. As shown in FIG. 2, the method includes the following steps.

S210: receiving, by each of the servos, a query instruction including a specific servo ID from the main controller of the robot.

S220: replying, by each of the servos, feedback information in a manner different from other of the servo, if the specific servo ID in the query instruction is equivalent to a local servo ID of the servo itself, where the feedback information is for the main controller to detect at least two of the servos with the same local servo ID on the bus.

If the query instruction is consistent with the local servo ID, for example, the specific servo ID in the query instruction is equivalent to the local servo ID, the feedback information can be replied in a manner different from other of the servo, where the feedback information is for the main controller to detect that there are at least two of the servos with the same local servo ID on the bus.

In one embodiment, step S220 includes: adding, by each of the servos, a unique identifier of the servo itself to the feedback information when generating the feedback information, if the specific servo ID in the query instruction is equivalent to the local servo ID of the servo itself; replying, by each of the servos, the feedback information including the unique identifier.

In which, when the feedback information is generated, the unique identifier such as a unique identification code of an MCU of the servo is added thereto. Since the unique identification code is set when the MCU is manufactured in the factory, there will be no duplication, and the unique identification code can be taken as additional information to be added to the feedback information. In this case, when the main controller sends a query instruction for the specific servo ID, different data information is replied when there are multiple servos that reply the feedback information. When different information appears on the bus of the robot at the same time, a superimposed information of the two different information will not pass the verification of the preset verification software. The advantage of this setting is that it can be determined that the specific servo ID is duplicate on the bus when there are different servos to reply the query instruction at the same time, which is beneficial to the improvement of the control accuracy of the robot, and can further guarantee the service life of the robot.

In one embodiment, step S220 includes; generating, by each of the servos, the feedback information and setting a reply delay duration as a random duration, if the specific servo ID in the query instruction is equivalent to the local servo ID of the servo itself; and reply ing, by each of the servos, the feedback information to the main controller after the reply delay duration.

In which, when the feedback information is generated, by introducing a random number, so that the time for replying the feedback information is a random time after the servo receives the query instruction of the main controller. In such manner, after the main controller sends a query instruction, the received replied feedback information can have a different time offset, so as to determine that the current specific servo ID is duplicate on the bus. It can directly monitor the next servo ID after monitoring die current specific servo ID.

In the technical solution provided by this embodiment, the query instruction including the specific servo ID is received, where the query instruction is transmitted by the main controller of the robot to all the servos of the robot; and the feedback information is replied in the manner different from other of the servo, if the specific servo ID in the query instruction is equivalent to the local servo ID of the servo itself, where the feedback information is for the main controller to detect at least two of the servos with the same local servo ID on the bus. Through the technical solution provided by this embodiment, the detection of duplicate servo ID can be realized, and the servos on the bus that have the same servo ID can be found so as to remind the user of the robot. thereby guaranteeing the normal operation of the robot

### Embodiment 3

FIG. 3 is a schematic block diagram of a main controller for a robot according to embodiment 3 of the present disclosure. As shown in FIG. 3, in this embodiment a main controller for a robot is provided. The main controller includes:

a query instruction transmitting module 310 configured to transmit a query instruction including a specific servo ID to at least two of the servos of the robot through a bus, and differentiate feedback information replied by at least two of the servos corresponding to the specific servo ID; and

a duplicate servo ID detecting module 320 configured to determine there being at least two of the servos with the same servo ID, if the feedback information not meeting a predetermined verification rule is receive.

In this embodiment, each of the above-mentioned modules is implemented in the form of software, which can be computer program(s) stored in a memory of the main controller and executable on a processor of the main controller. In other embodiments, each of the above-mentioned modules may be implemented in the form of hardware (e.g., a circuit of the main controller which is coupled to the processor of the main controller) or a combination of hardware and software (e.g., a circuit with a single chip microcomputer).

In the technical solution provided by this embodiment, the query instruction including the specific servo ID is transmitted to all the servos of the robot, where the query instruction is for causing at least one of the servos corresponding to the specific servo ID to reply feedback information: and the specific servo ID in the query instruction is determined as duplicated on the bus, if at least two sets of the feedback information corresponding to the query instruction have received. Through the technical solution provided by this embodiment, the detection of duplicate servo ID can be realized, and the servos on the bus that have the same servo ID can be found so as to remind the user of the robot, thereby guaranteeing the normal operation of the robot.

The above-mentioned main controller can perform the method provided in embodiment 1 of the present disclosure, which has the corresponding functional modules for executing the method and the corresponding beneficial effects.

### Embodiment 4

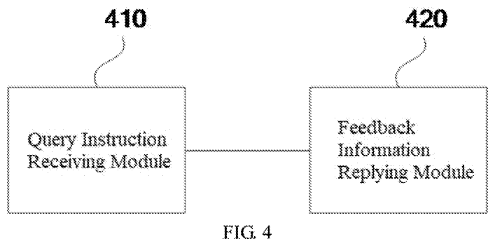

FIG. 4 is a schematic block diagram of a servo for a robot according to embodiment 4 of the present disclosure. As shown in FIG. 4, in this embodiment, a servo for a robot is provided. The serve includes:

a query instruction receiving module 410 configured to receive a query instruction including a specific servo ID from the main controller; and

a feedback information replying module 420 configured to reply feedback information, if the specific servo ID in lie query instruction is equivalent lo a local servo ID of the servo itself, where the feedback information is for the main controller to detect at least two of the servos of the robot with the same local servo ID on the bus.

In this embodiment, each of the above-mentioned modules is implemented in the form of software, which can be computer program(s) stored in a memory of the servo and executable on a processor of the servo. In other embodiments, each of the above-mentioned modules may be implemented in the form of hardware (e.g., a circuit of the servo which is coupled to the processor of the servo) or a combination of hardware and software (e.g., a circuit with a single chip microcomputer).

In the technical solution provided by this embodiment, the query instruction including the specific servo ID is received, where the query instruction is transmitted by the main controller of the robot to all the servos of the robot; and the feedback information is replied in the manner different from other of the servo, if the specific servo ID in the query instruction is equivalent to the local servo ID of the servo itself, where the feedback information is for the main controller to detect at least two of the servos with the same local servo ID on the bus. Through the technical solution provided by this embodiment, the detection of duplicate servo ID can be realized, and the servos on the bus that have the same servo ID can be found so as to remind the user of the robot, thereby guaranteeing the normal operation of the robot.

The above-mentioned servo can perform the method provided in embodiment 2 of the present disclosure, which has the corresponding functional modules for executing the method and the corresponding beneficial effects.

### Embodiment 5

The embodiments of the present disclosure further provides a storage medium including computer executable instructions for performing a duplicate servo ID detection method when executed by a processor of a computer. The method includes:

transmitting, by the main controller, a query instruction including a specific servo ID to all the servos of the robot, where the query instruction is for causing at least one of the servos corresponding to the specific servo ID to reply feedback information; and

determining, by the main controller, the specific servo ID in the query instruction as being duplicate on the bus, if the feedback information corresponding to the query instruction is received from at least two of the servos.

Alternatively, the method may include:

receiving, by each of the servos, a query instruction including a specific servo ID from the main controller of the robot; and

replying, by each of the servos, feedback information in a manner different from other of the servo, if the specific servo ID in the query instruction is equivalent to a local servo ID of the servo itself, where the feedback information is for the main controller to detect at least two of the servos with the same local servo ID on the bus.

The storage medium can be any type of memory or storage device. The term “storage medium” is intended to include: an installation medium such as a CD-ROM, a floppy disk, or a tape device; a memory of a computer system or a random access memory such as DRAM, DDR RAM, SRAM, EDO RAM, Rambus RAM, and the like; a non-volatile memory such as a flash memory, a magnetic media (e.g., a hard disk or an optical storage); and a register or other similar types of memory elements, and tire like. The storage medium may also include other types of memory or a combination thereof. In addition, the storage medium may be located in a computer system in which a program is executed, or may be located in a different second computer system, where the second computer system is connected to the computer system via a network (e.g., Internet). The second computer system can provide instructions for the computer to execute. The term “storage medium” can include two or more storage media that can reside in different locations (e.g., in different computer systems connected through a network), the storage medium can store instructions (which can be implemented as, for example, a computer program) executable by one or more processors.

In other embodiments, in the storage medium including computer executable instructions provided by this embodiment, the computer executable instructions are not limited to the above-mentioned detection operations that arc for duplicate servo ID detection, which can also include the related operations in the duplicate servo ID detection method provided by embodiment 1 or embodiment 2 of the present disclosure.

### Embodiment 6

The embodiments of the present disclosure further provide a robot integrated with the main controller provided by embodiment 3 of the present disclosure. FIG. 5 is a schematic block diagram of the structure of a robot according to embodiment 6 of the present disclosure. As shown in FIG. 5, in this embodiment, a robot 500 is provided. The robot 500 includes: one or more processors 520 and a storage device 510 for storing one or more programs. The one or more processors 520 implement the duplicate servo ID detection method provided by embodiment 1 of the present disclosure when the one or more programs are executed by the one or more processors 520. In which, the method includes:

transmitting, by the main controller, a query instruction comprising a specific servo ID to at least two of the servos of the robot through a bus;

differentiating feedback information replied by at least two of the servos corresponding to the specific servo ID; and

determining, by the main controller, there being at least two of the servos with the same servo ID, in response to receiving the feedback information not meeting a predetermined verification rule.

In other embodiments, those skilled in the art can understand that, the processor 520 can also implement the technical solution of the duplicate servo ID detection method provided by embodiment 1 of the present disclosure.

The robot 500 shown in FIG. 5 is merely an example, which will not impose any limitation on the function and the scope of the use of this embodiment.

As shown in FIG. 5, the robot 500 includes the processor 520, the storage device 510, an input device 530, and an output device 540. In the robot 500, the number of the processor 520 may be one or more, and one processor 520 is taken as an example in FIG. 5; and the processor 520, the storage device 510, the input device 530, and the output device 540 can be connected via a bus or other means, and connecting via the bus 550 is taken as an example in FIG. 5.

The storage device 510 is used as a computer readable storage medium, which can be used to store software programs, computer executable programs, and modules, for example, the instructions corresponding to the duplicate servo ID detection method in the embodiments of the present disclosure.

The storage device 510 may mainly include a program storage area and a data storage area, where the program storage area may store an operating system and an application program required for at least one function, the data storage area may store data created according to usage of the robot 500, and the like. Moreover, tire storage device 510 can include high speed random access memory, and can also include non-volatile memory such as at least one magnetic disk storage device, flash memory device, or other non-volatile solid state storage device. In some embodiments, the storage device 510 can further include a storage that remotely located with respect to processor 520, where the remote storage can be connected via a network. Examples of the above-mentioned network includes, but are not limited to, Internet, intranet, local area network, mobile communication network, and a combination thereof.

The input device 530 can be used to receive input digital, character, or voice information, as well as to generate key signal inputs related to the user settings and function control of the robot. The output device 540 can include a display, a speaker, and the like.

In this embodiment, the provided robot 500 can realize the detection of duplicate servo ID, and the servos on the bus that have the same servo ID can be found so as to remind the user of the robot, thereby guaranteeing the normal operation of the robot.

In the above-mentioned embodiments, the provided main controller for a robot, storage medium, and robot can perform the duplicate servo ID detection method provided by embodiment 1 of the present disclosure, and have the corresponding functional modules and beneficial effects of executing the method. For the technical details that are not described in detail in the above-mentioned embodiments, reference may be made to the duplicate servo ID detection method provided in embodiment 1 of the present disclosure.

### Embodiment 7

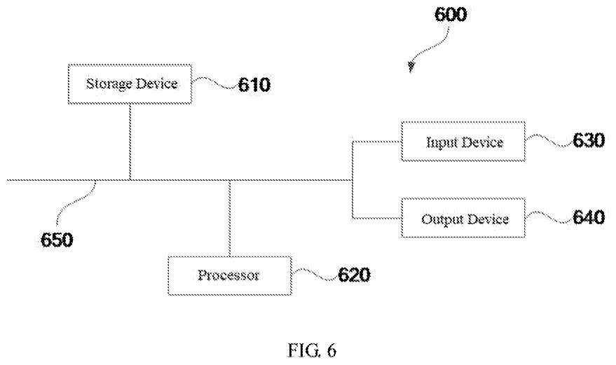

The embodiments of the present disclosure further provide a robot including servos. The servo can integrated with the servo for a robot provided by embodiment 4 of the present disclosure. FIG. 6 is a schematic block diagram of the structure of a servo of a robot according to embodiment 7 of the present disclosure. As shown in FIG. 6, in this embodiment, a servo 600 is provided. The servo 600 includes: one or more processors 620 and a storage device 610 for storing one or more programs. The one or more processors 620 implement the duplicate servo ID detection method provided by embodiment 2 of the present disclosure when the one or more programs are executed by the one or more processors 620. In which, the method includes:

receiving, by each of the servos, a query instruction including a specific servo ID from the main controller of the robot; and

replying, by each of the servos, feedback information in a manner different from other of the servo, if the specific servo ID in the query instruction is equivalent to a local servo ID of the servo itself, where the feedback information is for the main controller to detect at least two of the servos with the same local servo ID on the bus.

In other embodiments, those skilled in the art can understand that, the processor 620 can also implement the technical solution of the duplicate servo ID detection method provided by embodiment 2 of the present disclosure.

The servo 600 shown in FIG. 6 is merely an example, which will not impose any limitation on the function and the scope of the use of this embodiment.

As shown in FIG. 6, the servo 600 includes the processor 620, the storage device 610, an input device 630, and an output device 640. In the servo 600, the number of the processor 620 may be one or more, and one processor 620 is taken as an example in FIG. 6; and the processor 623, the storage device 610, the input device 630, and the output device 640 can be connected via a bus or other means, and connecting via the bus 650 is taken as an example in FIG. 6.

The storage device 610 is used as a computer readable storage medium, which can be used to store software programs, computer executable programs, and modules, for example, the instructions corresponding to the duplicate servo ID detection method in the embodiments of the present disclosure.

The storage device 610 may mainly include a program storage area and a data storage area, where the program storage area may store an operating system and an application program required for at least one function, the data storage area may store data created according to usage of the servo 600, and the like. Moreover, the storage device 610 can include high speed random access memory, and can also include non-volatile memory such as at least one magnetic disk storage device. Hash memory device, or other non-volatile solid stats storage device. In some embodiments, the storage device 610 can further include a storage that remotely located with respect to processor 620, where the remote storage can be connected via a network. Examples of the above-mentioned network includes, but are not limited to, Internet, intranet, local area network, mobile communication network, and a combination thereof.

The input device 630 can be used to receive input digital, character, or voice information, as well as to generate key signal inputs related to the user settings and function control of the robot. The output device 640 can include a display, a speaker, and the like.

In this embodiment, the provided servo 600 can realize the detection of duplicate servo ID, and the servos on the bus that have the same servo ID can be found so as to remind the user of the robot, thereby guaranteeing the normal operation of the robot.

In the above-mentioned embodiments, the provided servo for a robot, storage medium, and robot can perform the duplicate servo ID detection method provided by embodiment 2 of the present disclosure, and have the corresponding functional modules and beneficial effects of executing the method. For the technical details that are not described in detail in the above-mentioned embodiments, reference may be made to the duplicate servo ID detection method provided in embodiment 2 of the present disclosure.

It should be note that, the forgoing are only the preferred embodiments of the present disclosure and the technical principles applied thereto. Those skilled in the art will understand that, the present disclosure is not limited to the specific embodiments described herein, and various changes, modifications, and substitutions can be made by those skilled in the art without departing from the scope of the present disclosure. Therefore, although the present disclosure has been described in detail by the above embodiments, the present disclosure is not limited to the above embodiments, and other equivalent embodiments may be included without departing from the concept of the present disclosure, while the scope of the present disclosure is determined by the scope of the appended claims.

What is claimed is:

1. A computer-implemented duplicate servo ID detection method for a robot having a main controller and a plurality of servos, wherein the main controller and the plurality of servos communicate with each other via a bus, and the method comprises executing on a processor of the main controller the steps of:
transmitting, by the main controller, a query instruction comprising a specific servo ID to at least two of the servos of the robot through a bus;
differentiating feedback information replied by at least two of the servos corresponding to the specific servo ID; and
determining, by the main controller, there being at least two of the servos with the same servo ID, in response to receiving the feedback information not meeting a predetermined verification rule.

2. The method of claim 1, wherein the step of differentiating the feedback information replied by at least two of the servos corresponding to the specific servo ID comprises:
making reply times of at least two of the servos corresponding to the specific servo ID different.

3. The method of claim 1, wherein the step of differentiating the feedback information replied by at least two of the servos corresponding to the specific servo ID comprises:
adding an identification code of a MCU of each servo to the feedback information of the servo such that the feedback information replied by at least two of the servos at the same time different with each other to cause the feedback information received by the main controller not meeting the predetermined verification rule.

4. A computer-implemented duplicate servo ID detection method for a robot having a main controller and a plurality of servos, wherein the main controller and the plurality of servos communicate with each other via a bus, and the method comprises executing on a processor of each of the servos the steps of:
receiving, by each of the servos, a query instruction comprising a specific servo ID from the main controller; and
replying, by each of the servos, feedback information in a manner different from other of the servos, in response to the specific servo ID in the query instruction being equivalent to a local servo ID of the servo itself, wherein the feedback information is for the main controller to detect at least two of the servos with the same local servo ID on the bus.

5. The method of claim 4, wherein the step of replying, by each of the servos, the feedback information in the manner different from other of the servos, in response to the specific servo ID in the query instruction being equivalent to the local servo ID of the servo itself comprises:
adding, by each of the servos, a unique identifier of the servo itself to the feedback information when generating the feedback information, in response to the specific servo ID in the query instruction being equivalent to the local servo ID of the servo itself; and replying, by each of the servos, the feedback information comprising the unique identifier.

6. The method of claim 4, wherein the step of replying, by each of the servos, the feedback information in the manner different from other of the servos, in response to the specific servo ID in the query instruction being equivalent to the local servo ID of the servo itself comprises:
generating, by each of the servos, the feedback information and setting a reply delay duration as a random duration, in response to the specific servo ID in the query instruction being equivalent to the local servo ID of the servo itself; and replying, by each of the servos, the feedback information to the main controller after the reply delay duration.

7. A servo for a robot having a main controller, comprising: one or more processors; and
a storage device for storing one or more programs executable on the one or more processors, wherein the one or more programs comprise:
a query instruction receiving module configured to receive a query instruction comprising a specific servo ID from the main controller; and
a feedback information replying module configured to reply feedback information, in response to the specific servo ID in the query instruction being equivalent to a local servo ID of the servo itself, and differentiate the feedback information, wherein the differentiated feedback information is for the main controller to detect at least two of the servos of the robot with the same local servo ID on the bus.

8. The servo of claim 7, wherein the feedback information replying module is configured to:
add a unique identifier of the servo itself to the feedback information when generating the feedback information, in response to the specific servo ID in the query instruction being equivalent to the local servo ID of the servo itself; and reply the feedback information comprising the unique identifier.

9. The servo of claim 7, wherein the feedback information replying module is configured to:
generate the feedback information and setting a reply delay duration as a random duration, in response to the specific servo ID in the query instruction being equivalent to the local servo ID of the servo itself; and
reply the feedback information to the main controller after the reply delay duration.
